(19) United States
(12) Patent Application Publication
(10) Pub. No.: US 2026/0246401 A1
(43) Pub. Date: Aug. 20, 2026

(54) MOTOR CONTROL DEVICE AND IMAGE FORMING APPARATUS

(71) Applicant: CANON KABUSHIKI KAISHA, Tokyo (JP)

(72) Inventors: SHUHEI HAMADA, Chiba (JP); MASAYA MORITA, Ibaraki (JP)

(21) Appl. No.: 19/539,963

(22) Filed: Feb. 13, 2026

(30) Foreign Application Priority Data
Feb. 17, 2025 (JP) 2025-023291

(51) Int. Cl. H02P 6/16; H02P 21/22

(52) U.S. Cl. CPC H02P 6/16; H02P 21/22

(57) ABSTRACT

A motor control device includes a motor, a driving target driven by the motor, a position information detection unit configured to detect operation position information of the driving target, and a driving control portion configured to generate electrical angle information of the motor based on position information detected by the position information detection unit when the motor is moved to a specific electrical angle position and information of the specific electrical angle position, and control driving of the motor.

### BACKGROUND

### Field of the Technology

The present disclosure relates to a motor control device in an image forming apparatus such as a copying machine, a printer, a facsimile, or a multifunction device having a plurality of functions thereof, and an image forming apparatus equipped with the motor control device.

### Description of the Related Art

In recent years, an image forming apparatus has been required to improve a printing speed and extend a service life of a service part, and accordingly, an increase in output of a motor used in the image forming apparatus has been required.

In order to cope with this increase in output of the motor, Japanese Patent Application Laid-Open No. 2021-22979 proposes a method of driving a load that is a driving target, by using a plurality of small motors. As described above, by using a plurality of inexpensive small motors, it is possible to obtain high output with an inexpensive configuration without using a large and high-output expensive motor.

FIG. 9 is an explanatory diagram illustrating a conventional configuration in which one rotating member is controlled with high accuracy by a plurality of motors as proposed in Japanese Patent Application Laid-Open No. 2021-22979.

In FIG. 9, a first motor 4021 and a second motor 4031 are linked to a speed reducer 4041, and the speed reducer 4041 is linked to a rotating member 4091 that is a load. With this configuration, the rotating member 4091 can be rotated by the two motors 4021 and 4031.

In this configuration, the first motor 4021 and the second motor 4031 are provided with a first rotation position sensor 4051 and a second rotation position sensor 4052 that are sensors for detecting respective rotation positions. By applying voltages from a first driving voltage generation circuit 4061 and a second driving voltage generation circuit 4062 to rotation positions at which the motor can efficiently rotate based on rotation position information of the motor from the first rotation position sensor 4051 and the second rotation position sensor 4052, responsiveness of the motor is increased, and highly accurate driving can be performed.

The rotating member 4091 is provided with a third rotation position sensor 4053 for detecting the speed or the position, and the first driving voltage generation circuit 4061 and the second driving voltage generation circuit 4062 control the driving voltage according to speed or position information from the third rotation position sensor 4053, so that the rotating member 4091 can be driven with high accuracy.

As described above, in the conventional configuration, in order to control one rotating member 4091 with high accuracy by the plurality of motors 4021 and 4031, the rotation position detection sensor is provided in each motor, and the rotation position detection sensor is further provided in the rotating member 4091 that is a load.

However, providing the position detection sensor in each motor and providing the position detection sensor in the rotating member that is the load as described above lead to an increase in the cost of the entire apparatus.

### SUMMARY

The present disclosure has been made in view of the above circumstances, and it is desirable to provide a motor control device capable of obtaining motor driving performance equivalent to that of a configuration provided with a position detection sensor even though the position detection sensor provided for a motor is eliminated, and capable of achieving cost reduction, and an image forming apparatus equipped with the motor control device.

According to the present disclosure, there are provided a motor control device including a motor, a driving target driven by the motor, a position information detection unit configured to detect operation position information of the driving target, and a driving control portion configured to generate electrical angle information of the motor based on position information detected by the position information detection unit when the motor is moved to a specific electrical angle position and information of the specific electrical angle position, and control driving of the motor, and an image forming apparatus equipped with the motor control device.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic front cross-sectional view of an image forming apparatus according to an embodiment of the present disclosure.

FIG. 2 is a circuit block diagram illustrating a control circuit configuration of the image forming apparatus according to the embodiment of the present disclosure.

FIG. 3 is a block diagram of a motor control device and a control target of the motor control device according to the embodiment of the present disclosure.

FIG. 4 is a detailed block diagram of a first driving voltage generation circuit according to the embodiment of the present disclosure.

FIG. 5 is a detailed block diagram of a driving voltage command generation circuit according to the embodiment of the present disclosure.

FIG. 6 is a detailed block diagram of an electrical angle calculation circuit according to the embodiment of the present disclosure.

FIG. 7 is a flowchart illustrating control of the motor control device in a CPU according to the embodiment of the present disclosure.

FIG. 8 is an explanatory diagram of a method of acquiring a correction value of an electrical angle of each of two motors according to the embodiment of the present disclosure.

FIG. 9 is an explanatory diagram of a conventional configuration in which one rotating member is controlled by a plurality of motors.

### DESCRIPTION OF THE EMBODIMENTS

Hereinafter, preferred embodiments of the present disclosure will be described in detail with reference to the drawings. The constituent elements described in the following embodiments are merely examples, and various conditions such as a configuration, a function, a dimension, a material, a shape, a relative arrangement, and the like of an apparatus to which the present disclosure is applied can be appropriately modified or changed without departing from the gist of the present disclosure, and are not limited to the following embodiments.

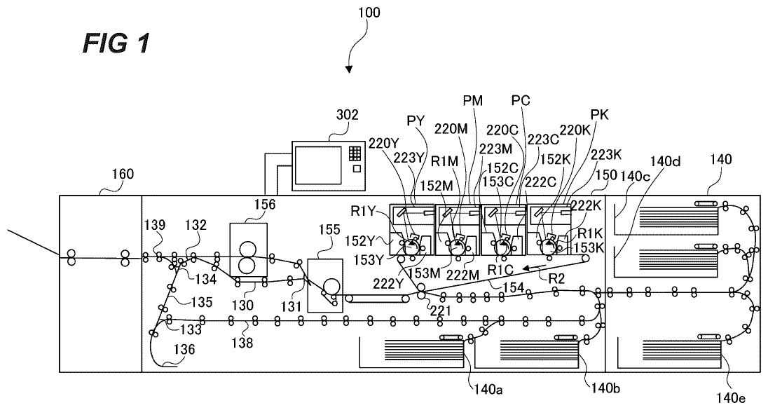

FIG. 1 is a schematic front cross-sectional view of an image forming apparatus according to an embodiment of the present disclosure.

In FIG. 1, an image forming apparatus 100 includes a sheet feeding device 140, a printer 150, and a finisher 160.

The sheet feeding device 140 is a device that feeds a stacked recording sheet as a recording material to the printer 150. The recording sheets are stacked on sheet feeding trays 140a, 140b, 140c, 140d, and 140e. The stacked recording sheet is fed and conveyed in a manner that a motor which will be described later rotates various rollers, and is sent to the printer 150. The sheet feeding trays 140a and 140b are built in the printer 150.

The printer 150 as an image forming section includes four image forming units PY, PM, PC, and PK. The four image forming units PY, PM, PC, and PK include an image forming unit PY that forms a yellow (Y) image, an image forming unit PM that forms a magenta (M) image, an image forming unit PC that forms a cyan (C) image, and an image forming unit PK that forms a black (K) image. Since the configurations of the image forming units PY, PM, PC, and PK are substantially the same except that developing colors are different, the image forming unit PY of the yellow color will be described in detail below, and the other image forming units PM, PC, and PK will be described by assigning the same reference numerals and signs M, C, and K to the corresponding configurations, and description thereof will be omitted.

The image forming unit PY includes a photosensitive drum 153Y, a charger 220Y, an exposure device 223Y, a development device 152Y, and a cleaner 222Y. The photosensitive drum 153 is rotated in a direction of an arrow R1Y by a motor which will be described later. The charger 220Y charges the surface of the photosensitive drum 153Y. The exposure device 223Y exposes the photosensitive drum 153Y. As a result, an electrostatic latent image is formed on the photosensitive drum 153Y. The development device 152Y develops the electrostatic latent image by using a developer (toner). As a result, the electrostatic latent image on the photosensitive drum 153Y is visualized, and a toner image is formed on the photosensitive drum 153Y. The toner image formed on the photosensitive drum 153Y is transferred to an intermediate transfer belt 154. The toner remaining on the photosensitive drum 153Y after being transferred to the intermediate transfer belt 154 is removed by the cleaner 222Y.

Images of the yellow color, the magenta color, the cyan color, and the black color, which are formed by the image forming units PY, PM, PC, and PK, are transferred to the intermediate transfer belt 154 to overlap each other. As a result, a full-color image is formed on the intermediate transfer belt 154. The image on the intermediate transfer belt 154 is conveyed in a direction of an arrow R2. The image formed on the intermediate transfer belt 154 is transferred to a recording sheet conveyed from the sheet feeding device 140 at a nip portion between the intermediate transfer belt 154 and a transfer roller 221. The intermediate transfer belt 154 is conveyed in the direction of the arrow R2 in a manner that a motor which will be described later rotates a driving roller.

The printer 150 includes a first fixing device 155 and a second fixing device 156 that fix an image on a recording sheet by heating and pressurizing the image transferred to the recording sheet. The first fixing device 155 includes a fixing roller having a heater therein, and a pressurizing belt for pressing the recording sheet against the fixing roller. The fixing roller is driven by a motor which will be described later to convey the recording sheet. The second fixing device 156 is disposed on the downstream side of the first fixing device in a conveyance direction of the recording sheet. The second fixing device 156 increases the glossiness with respect to the image on the recording sheet that has passed through the first fixing device 155, and secures the fixability. The second fixing device 156 includes a fixing roller having a heater therein and a pressurizing roller having a heater therein. There is no need to use the second fixing device 156 depending on the type of recording sheet. In this case, the recording sheet is conveyed to a conveyance path 130 without passing through the second fixing device 156. A flapper 131 performs switching between guiding the recording sheet to the conveyance path 130 and guiding the recording sheet to the second fixing device 156.

A flapper 132 performs switching between guiding the recording sheet to a conveyance path 135 and guiding the recording sheet to an ejection path 139. In a duplex printing mode, the flapper 132 guides a recording sheet on which an image is formed on a first surface to the conveyance path 135. In a face-up sheet ejection mode, the flapper 132 guides the recording sheet on which the image is formed on the first surface to the ejection path 139. In a face-down sheet ejection mode, the flapper 132 guides the recording sheet on which the image is formed on the first surface to the conveyance path 135. After an adjustment chart is printed on the first surface of the recording sheet, the flapper 132 guides the recording sheet to the conveyance path 135 in order to print the adjustment chart on a second surface of the recording sheet.

The recording sheet conveyed to the conveyance path 135 is conveyed to a reversing portion 136. The recording sheet conveyed to the reversing portion 136 is switched back to reverse the conveyance direction of the recording sheet after a conveyance operation is temporarily stopped. Then, it is switched whether a flapper 133 guides the recording sheet to a conveyance path 138 or the conveyance path 135. The flapper 133 guides the switched-back recording sheet to the conveyance path 138 in the duplex printing mode. The flapper 133 guides the switched-back recording sheet to the conveyance path 135 in the face-down sheet ejection mode. The recording sheet conveyed to the conveyance path 135 by the flapper 133 is guided to the ejection path 139 by a flapper 134. The flapper 133 guides the switched-back recording sheet to the conveyance path 138 in order to print the adjustment chart on the second surface of the recording sheet.

The recording sheet conveyed to the conveyance path 138 by the flapper 133 is conveyed toward the nip portion between the intermediate transfer belt 154 and the transfer roller 221. As a result, the front and back sides of the recording sheet when the sheet passes through the nip portion are reversed.

The recording sheet is conveyed in the printer 150 in a manner that a motor which will be described later rotates a driving roller.

The finisher 160 is a post-processing device that performs post-processing on the recording sheet from the printer 150. The finisher 160 performs, for example, a stapling process and a sorting process on a plurality of recording sheets.

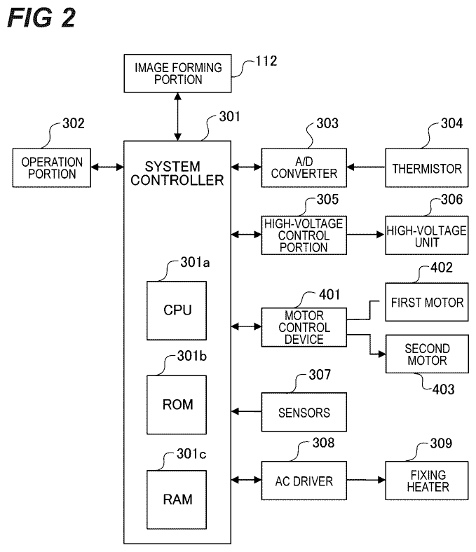

FIG. 2 is a circuit block diagram illustrating a control circuit configuration of the image forming apparatus 100.

In FIG. 2, a system controller 301 includes a CPU 301a, a ROM 301b, and a RAM 301c. The system controller 301 is connected to an image processing portion 112, an operation portion 302, an analog/digital (A/D) converter 303, a high-voltage control portion 305, a motor control device 401, sensors 307, and an AC driver 308. The system controller 301 can transmit and receive data and commands to and from the connected respective units.

The CPU 301a reads and executes various programs stored in the ROM 301b to execute various sequences related to a predetermined image forming sequence. The RAM 301c is a storage device. The RAM 301c stores, for example, various data such as a setting value for the high-voltage control portion 305, a command value for the motor control device 401, and information received from the operation portion 302.

The system controller 301 transmits setting value data of various devices provided inside the printer 150, which is necessary for image processing in the image processing portion 112, to the image processing portion 112.

The system controller 301 further receives a signal from the sensors 307 and sets a setting value of the high-voltage control portion 305 based on the received signal. The high-voltage control portion 305 supplies a necessary voltage to a high-voltage unit 306 (charger 220, development device 152, and the like) according to a setting value set by the system controller 301. The sensors 307 include a sensor or the like that detects a recording sheet conveyed by a conveying roller.

The motor control device 401 controls the first motor 402 as a first motor and the second motor 403 as a second motor, which drive a load, according to a command output from the CPU 301a. Although only one motor control device 401 is illustrated in FIG. 2, a plurality of motor control devices is actually provided in the image forming apparatus 100.

The A/D converter 303 receives a detection signal detected by a thermistor 304 for detecting the temperature of a fixing heater 309, converts the detection signal from an analog signal to a digital signal, and transmits the digital signal to the system controller 301. The system controller 301 controls the AC driver 308 based on the digital signal received from the A/D converter 303. The AC driver 308 controls the fixing heater 309 such that the temperature of the fixing heater 309 becomes a temperature necessary for performing a fixing process. The fixing heater 309 is a heater used for the fixing process, and is provided in the first fixing device 155 and the second fixing device 156.

The system controller 301 controls the operation portion 302 such that an operation screen for a user to set the type (referred to as a sheet type below) of the recording sheet to be used or the like is displayed on a display portion provided in the operation portion 302. The system controller 301 receives information set by the user from the operation portion 302, and controls an operation sequence of the image forming apparatus 100 based on the information set by the user. The system controller 301 transmits information indicating the state of the image forming apparatus 100 to the operation portion 302. The information indicating the state of the image forming apparatus 100 is, for example, information regarding the number of sheets for image formation, the progress status of an image forming operation, the jam or double feed of recording sheets, and the like. The operation portion 302 displays the information received from the system controller 301 on the display portion.

As described above, the system controller 301 controls the operation sequence of the image forming apparatus 100.

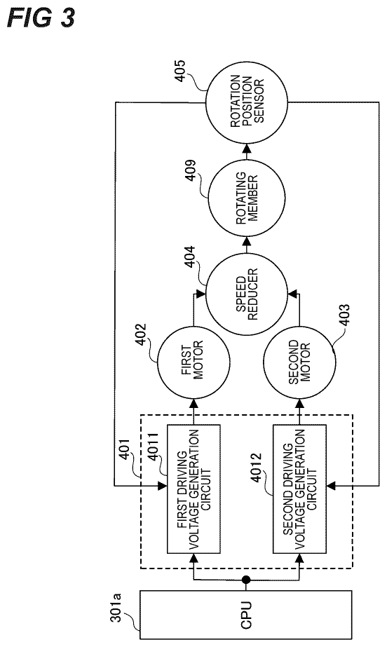

Next, the motor control device 401 will be described with reference to FIG. 3. FIG. 3 is a block diagram of the motor control device 401 and a control target of the motor control device 401.

In FIG. 3, the CPU 301a controls the motor control device 401 by outputting a control signal related to motor control to the motor control device 401. In this control signal, 0 is a signal for an instruction of non-control, 1 is a signal for an instruction of positioning control of the first motor 402, 2 is a signal for an instruction of positioning control of the second motor 403, and 3 is a signal for an instruction of rotation control of the first motor 402 and the second motor 403.

The control signal outputs 0 in a state where the first motor 402 and the second motor 403 are not rotating. When the CPU 301a receives a command to start control of the first motor 402 and the second motor 403, the control signal transitions in the order of 1→2→3. During periods of the control signals 1 and 2, correction values necessary for controlling the first motor 402 and the second motor 403 are acquired. When there is no correction value, control performance of the motor is deteriorated or control is not possible.

The motor control device 401 generates driving voltages to be applied to the first motor 402 and the second motor 403 based on a control signal from the CPU 301a and a pulse signal that is rotation position information indicating a rotation position of the rotating member 409 from the rotation position sensor 405, and controls these two motors. The motor control device 401 includes a first driving voltage generation circuit 4011 that generates a driving voltage to be applied to the first motor 402 and a second driving voltage generation circuit 4012 that generates a driving voltage to be applied to the second motor 403, and the first driving voltage generation circuit 4011 and the second driving voltage generation circuit 4012 have the same function.

The first motor 402 and the second motor 403 are three-phase DC brushless motors. In the present embodiment, an example using three-phase DC brushless motors as the first motor 402 and the second motor 403 will be described, but the present disclosure is not limited to the DC brushless motors. The present disclosure is not limited to the same type of motor.

A speed reducer 404 as a driving force transmission unit composes torque (driving force) generated by the first motor 402 and the second motor 403 and transmits the composed torque to the rotating member 409 as a driving target that is a load. In the present embodiment, an example in which the reduction ratios of the two motors and the speed reducer are the same will be described, but the reduction ratios may be different.

The rotating member 409 rotates by the torque transmitted by the speed reducer 404. The rotating member corresponds to the photosensitive drum 153, the fixing roller, a driving roller of the intermediate transfer belt, a conveyance driving roller of a recording sheet, and the like in the image forming apparatus 100.

The rotation position sensor 405 as a position information detection unit detects a rotation position that is operation position information of the rotating member 409. A rotary encoder or the like is used to detect the rotation position. The rotary encoder includes a light emitting portion that emits light, a light receiving portion that receives light emitted from the light emitting portion, and a disk in which a slit through which the light emitted from the light emitting portion passes is provided at each predetermined rotation position, and outputs a pulse signal as a detection result each time the light receiving portion receives the light.

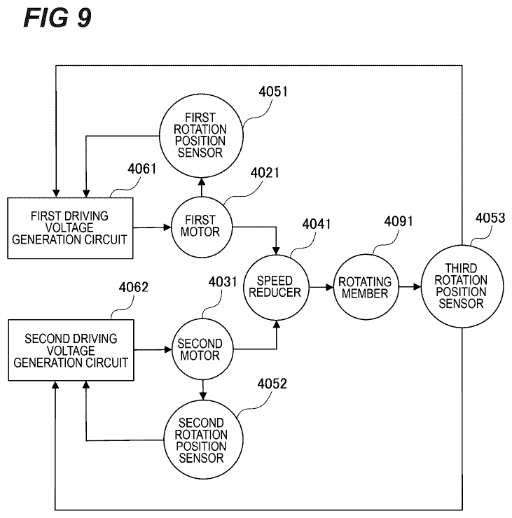

The motor control device 401, the rotating member 409 that is a control target, the first motor 402 and the second motor 403 that apply driving forces to the rotating member 409, the speed reducer 404, and the rotation position sensor 405 that detects the rotation position of the rotating member 409, which are illustrated in FIG. 3, have been described above. As illustrated in FIG. 3, in the present embodiment, the first motor 402 and the second motor 403 have a configuration in which the first rotation position sensor 4051 and the second rotation position sensor 4052 as illustrated in the conventional example of FIG. 9 are not provided.

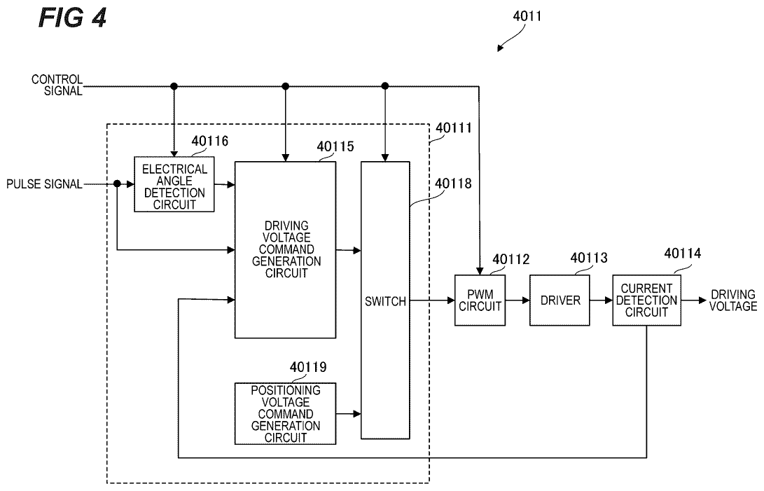

Next, the first driving voltage generation circuit 4011 and the second driving voltage generation circuit 4012 that generate voltages to be applied to the first motor 402 and the second motor 403 in the motor control device 401 will be described. Since the second driving voltage generation circuit 4012 has the similar configuration to that of the first driving voltage generation circuit 4011, only a difference from the first driving voltage generation circuit 4011 will be described. FIG. 4 is a detailed block diagram of the first driving voltage generation circuit 4011.

In FIG. 4, the first driving voltage generation circuit 4011 includes a voltage command generation circuit 40111, a PWM generation circuit 40112, a driver 40113, and a current detection circuit 40114.

The voltage command generation circuit 40111 as a driving control portion outputs a command value of a voltage to be applied to the first motor 402. Details of the voltage command generation circuit 40111 will be described later.

The PWM generation circuit 40112 and the driver 40113 generate a driving voltage based on a voltage command value from the voltage command generation circuit 40111.

The PWM generation circuit 40112 outputs a PWM signal based on a control signal from the CPU 301a and a voltage command output from a switch 40118. In a case where the control signal from the CPU 301a is 0, the PWM generation circuit is turned off, and in a case where the control signal is other than 0, the PWM generation circuit is turned on.

The driver 40113 outputs a PWM voltage to be applied to the first motor 402 based on the PWM signal from the PWM generation circuit 40112.

The current detection circuit 40114 detects a three-phase current flowing through the first motor 402. The detected current value is used by the voltage command generation circuit 40111. The current detection circuit 40114 is generally provided with a current detection resistor, and detects a current value in a manner that the A/D converter 303 detects a voltage applied to both ends of the current detection resistor.

The above description is an outline of the configuration of the first driving voltage generation circuit 4011.

Next, details of the voltage command generation circuit 40111 that generates the command value of the voltage to be applied to the first motor 402 will be described.

The voltage command generation circuit 40111 has a function of outputting two types of voltage commands. The two types of voltage commands are generated by voltage commands of a driving voltage command generation circuit 40115 and a positioning voltage command generation circuit 40119.

The driving voltage command generation circuit 40115 as a driving voltage generation unit generates a voltage command value of a driving voltage to be applied to the first motor 402, and has a configuration combining speed control and vector control. Speed control is used to determine the necessary torque of the first motor 402 based on speed information of the rotating member 409, and vector control is used to realize control with high torque controllability capable of instantaneously generating the necessary torque.

The positioning voltage command generation circuit 40119 generates a voltage command for performing positioning control of the first motor 402.

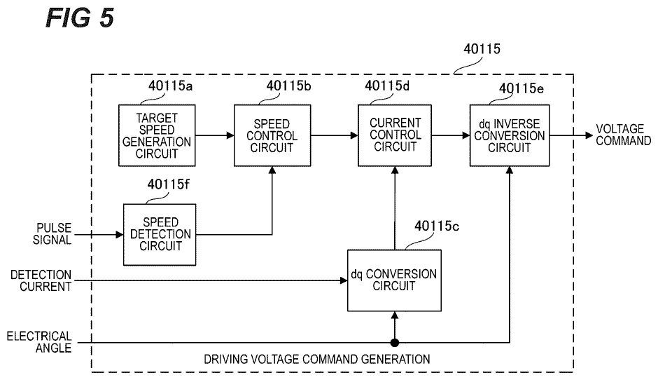

The driving voltage command generation circuit 40115 will be described with reference to FIG. 5. FIG. 5 is a detailed block diagram of the driving voltage command generation circuit 40115.

The driving voltage command generation circuit 40115 starts an operation based on the control signal from the CPU 301a. The operation is performed in a case where the control signal from the CPU 301a is 3, and the operation is not performed in other cases.

When the control signal from the CPU 301a is 3 and the operation is started, a target speed generation circuit 40115a determines and outputs a target speed signal based on an initial speed, a target speed, and an acceleration, which have been set in advance. When the control signal from the CPU 301a is switched to 0 again and the motor control device 401 stops operating, the target speed generation circuit 40115a decelerates the target speed signal based on the deceleration set in advance, and finally sets the target speed signal to 0.

A speed detection circuit 40115f detects the speed of the rotating member 409 from the pulse signal of the rotation position sensor 405. The cycle of the pulse signal is measured, and the speed is calculated from the cycle.

A speed control circuit 40115b outputs a d-axis current command and a q-axis current command. The d-axis current command is output as a fixed value of 0. The q-axis current command determines a value such that the target speed signal coincides with a detection speed of the rotating member 409. Specifically, the q-axis current command is determined by calculating a deviation that is a difference between the target speed and the detection speed and performing PI control on the deviation.

A dq conversion circuit 40115c calculates the d-axis detection current and the q-axis detection current from a detection current from the current detection circuit 40114 and the electrical angle, and outputs the d-axis detection current and the q-axis detection current. A calculation expression is the following expression [Math. 1].

$$( \begin{matrix}{I}_{d} \\ {I}_{q}\end{matrix} ) = ( \begin{matrix}cos θ & sin θ \\ - sin θ & cos θ\end{matrix} ) ( \begin{matrix}1 & - \frac{1}{2} & - \frac{1}{2} \\ 0 & \frac{\sqrt{3}}{2} & - \frac{\sqrt{3}}{2}\end{matrix} ) ( \begin{matrix}{I}_{u} \\ {I}_{v} \\ {I}_{w}\end{matrix} ) \qquad [ Math . 1 ]$$

A current control circuit 40115d that controls the driving current of first motor 402 determines a d-axis voltage command and a q-axis voltage command from a d-axis current command and a q-axis current command output from the speed control circuit 40115b and a d-axis detection current and a q-axis detection current output from the dq conversion circuit 40115c. The d-axis voltage command is determined by performing PI control on a deviation between the d-axis current command and the d-axis detection current. Similarly, the q-axis voltage command is determined by performing PI control on a deviation between the q-axis current command and the q-axis detection current.

A dq inverse conversion circuit 40115e calculates and outputs a U-phase voltage command, a V-phase voltage command, and a W-phase voltage command from the d-axis voltage command, the q-axis voltage command, and the electrical angle. A calculation expression is the following expression [Math. 2].

$$( \begin{matrix}{V}_{u} \\ {V}_{v} \\ {V}_{w}\end{matrix} ) = ( \begin{matrix}1 & 0 \\ - \frac{1}{2} & \frac{\sqrt{3}}{2} \\ - \frac{1}{2} & - \frac{\sqrt{3}}{2}\end{matrix} ) ( \begin{matrix}cos θ & - sin θ \\ sin θ & cos θ\end{matrix} ) ( \begin{matrix}{V}_{d} \\ {V}_{q}\end{matrix} ) \qquad [ Math . 2 ]$$

The driving voltage command generation circuit 40115 has been described above. As described above, when the control signal from the CPU 301a is 3, the driving voltage command generation circuit 40115 generates a driving voltage command based on the value of the current flowing through the first motor 402, the rotational speed of the rotating member 409, and the electrical angle of the first motor 402.

In a case where the control signal from the CPU 301a is other than 3, the U-phase voltage command, the V-phase voltage command, and the W-phase voltage command all output 0.

In the present embodiment, a configuration of the speed control and the vector control is adopted in the driving voltage command generation circuit 40115, but the driving voltage command generation circuit 40115 is not limited to this control configuration. Other configurations may be adopted as long as, in the configuration, the speed or position of the rotating member 409 is controlled and the driving voltage command is generated by using the electrical angle of the motor.

Next, the description returns to the first driving voltage generation circuit 4011 in FIG. 4.

In the description of the driving voltage command generation circuit 40115, it has been described that the current flowing through the first motor 402, the rotational speed of the rotating member 409, and the electrical angle of the first motor 402 are necessary. A method of detecting the electrical angle of the first motor 402 will be described below.

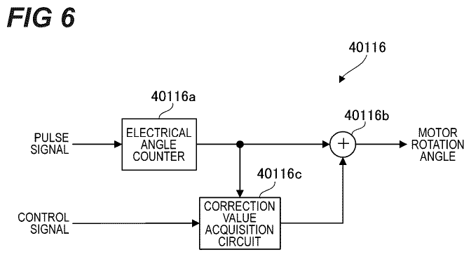

An electrical angle detection circuit 40116 outputs an electrical angle of the first motor 402 based on a pulse signal from the rotation position sensor 405. The electrical angle detection circuit 40116 of the first motor 402 will be described with reference to FIG. 6. FIG. 6 is a detailed block diagram of the electrical angle detection circuit 40116.

In FIG. 6, the electrical angle detection circuit 40116 includes an electrical angle counter 40116a, an adder 40116b, and a correction value acquisition circuit 40116c.

The electrical angle counter 40116a generates a signal indicating the rotation position of one round of the motor from the pulse signal output from the rotation position sensor 405. An example in which the motor has the number of poles of 10, the reduction ratio of the speed reducer 404 is 10, and the rotary encoder used in the rotation position sensor 405 is 4000 ppr will be described. When the first motor 402 makes one rotation, the rotation position sensor 405 outputs 400 pulse signals. Since the number of poles of the first motor 402 is 10, the number of pulses per electrical angle is 80. The electrical angle of the first motor 402 per pulse is 4.5 degrees. Therefore, when a counter that counts up 4.5 degrees with one pulse and resets to 0 at 360 degrees is produced, an electrical angle can be generated. The configuration of the electrical angle counter 40116a varies depending on the type of motor and the reduction ratio.

The electrical angle output from the electrical angle counter 40116a is such that a stop position when the apparatus is started up is 0 degrees and does not coincide with the actual electrical angle of the first motor 402, and the stop position differs every time the apparatus is started up.

The adder 40116b adds a correction value to the electrical angle of the first motor 402 output from the electrical angle counter 40116a, and outputs the result of addition. The correction value is an angle value for causing the electrical angle to coincide with the actual electrical angle of the first motor 402.

The correction value acquisition circuit 40116c acquires a correction value for setting the electrical angle output from the electrical angle counter 40116a to a correct electrical angle.

A method in which the correction value acquisition circuit 40116c obtains the correction value of the electrical angle will be described.

The correction value of the electrical angle is obtained by using the positioning voltage command generation circuit 40119 and the switch 40118 in FIG. 4.

The positioning voltage command generation circuit 40119 generates a voltage command for performing a positioning operation of moving the first motor 402 to a specific electrical angle position. This voltage command is a DC voltage value. For example, (U-phase voltage command, V-phase voltage command, W-phase voltage command)=(0 V, 12 V, −12 V). When the switch 40118 selects and outputs the output of the positioning voltage command generation circuit 40119, this voltage is applied to the motor, and the first motor 402 moves to an electrical angle of 90 degrees.

The correction value acquisition circuit 40116c applies the voltage of the positioning voltage command generation circuit 40119 to the first motor 402, and obtains the correction value from a difference between the electrical angle output from the electrical angle counter 40116a and the specific electrical angle after the first motor 402 moves to the position of the specific electrical angle. A timing at which the correction value is obtained is a timing at which the first motor 402 moves to the position of the specific electrical angle and completely stops. This timing is determined based on a control signal from the CPU 301a. This timing is a timing at which a predetermined time has elapsed after a positioning voltage is applied according to the control signal from the CPU 301a.

A flow of obtaining a correction value will be specifically described below with an example in which the first motor 402 is stopped at a position of an electrical angle of 30 degrees.

First, the positioning voltage command generation circuit 40119 applies (U-phase voltage command, V-phase voltage command, W-phase voltage command)=(0 V, 12 V, −12 V) to the first motor 402. When a voltage is applied, the first motor 402 moves to a position at an electrical angle of 90 degrees, which is a position at the specific electrical angle, and then stops. At that time, the electrical angle detection circuit 40116 starts at the electrical angle of 0 degrees, and counts up the electrical angle by the movement amount of the first motor 402 based on the pulse signal.

Since the electrical angle of the positioning voltage command generation circuit 40119 before the voltage application is 30 degrees, the movement amount of the first motor 402 is 60 degrees. Therefore, the output of the electrical angle detection circuit 40116 is 60 degrees.

Here, it can be seen that the deviation between the actual electrical angle of 90 degrees of the first motor 402 and the output of the electrical angle detection circuit 40116 is 30 degrees. That is, the correction value in this case is 30 degrees.

By inputting the correction value of 30 degrees to the electrical angle detection circuit 40116, the electrical angle detection circuit 40116 can output a correct electrical angle.

As described above, by applying a fixed DC voltage that is a positioning voltage of the first motor 402 and moving the first motor 402 to the specific electrical angle position, it is possible to obtain a correction value that is a difference between the output electrical angle of the electrical angle detection circuit 40116 and the actual electrical angle.

By using the positioning voltage command generation circuit 40119, the electrical angle detection circuit 40116 can detect a correct electrical angle. As a result, the driving voltage command generation circuit 40115 can control the motor with high accuracy by using the electrical angle information.

Next, differences of the second driving voltage generation circuit 4012 from the first driving voltage generation circuit 4011 will be described.

The second driving voltage generation circuit 4012 is different from the first driving voltage generation circuit 4011 in an operation of the switch 40118 in FIG. 4. Other configurations of the second driving voltage generation circuit 4012 are similar to those of the first driving voltage generation circuit 4011, and thus the corresponding configurations will be described below with the same reference numerals.

The switch 40118 selects and outputs an input according to a control signal from the CPU 301a. The control signal from the CPU 301a transitions in the order of 0, 1, 2, and 3.

The first driving voltage generation circuit 4011 selects the positioning voltage command generation circuit 40119 in a case where the control signal from the CPU 301a is 1, and selects the output of the driving voltage command generation circuit 40115 otherwise.

The second driving voltage generation circuit 4012 selects the positioning voltage command generation circuit 40119 in a case where the control signal from the CPU 301a is 2, and selects the output of the driving voltage command generation circuit 40115 otherwise.

The reason why the timing of applying the positioning voltage in the first driving voltage generation circuit 4011 and the second driving voltage generation circuit 4012 deviates by the control signal from the CPU 301a will be described.

As described above, the first driving voltage generation circuit 4011 applies a positioning voltage to the first motor 402 to move the first motor 402 to the specific electrical angle position, thereby obtaining a correction value for obtaining an accurate electrical angle.

The second driving voltage generation circuit 4012 also needs to obtain a correction value for the second motor 403 in a similar method.

However, when the first driving voltage generation circuit 4011 and the second driving voltage generation circuit 4012 simultaneously apply the positioning voltages to the first motor 402 and the second motor 403, it is not possible to obtain correct correction values.

This is because, when the positioning voltages are simultaneously applied to the first motor 402 and the second motor 403, in a case where the rotation directions of the first motor 402 and the second motor 403 are opposite or in a case where the rotation amounts are different even if the rotation directions are the same, the driving forces of the two motors repel each other and the motors stop at positions different from the specific electrical angle position. This is because the first motor 402 and the second motor 403 are linked by the speed reducer 404.

Therefore, the positioning voltage needs to be applied to the first motor 402 and the second motor 403 not simultaneously but at different timings. Both the motors can obtain correct correction values by voltage application at different timings.

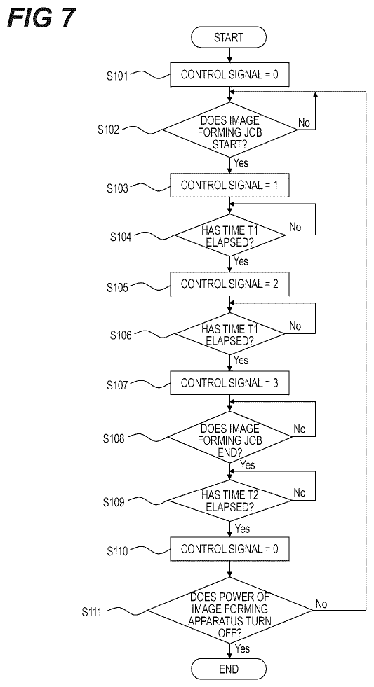

As described above, the motor control device 401 operates based on the control signal from the CPU 301a. The control of the motor control device 401 by the CPU 301a will be described with reference to FIG. 7. FIG. 7 is a flowchart illustrating the control of the motor control device 401 in the CPU 301a.

When the power of the image forming apparatus 100 is turned on, the CPU 301a outputs the control signal-0 in Step S101. In this state, no voltage is applied to the first motor 402 and the second motor 403, and no control is performed.

When an image forming job is started, the process transitions from Step S102 to Step S103.

In Step S103, the CPU 301a outputs the control signal=1. As a result, the positioning voltage is applied to the first motor 402, and the first motor rotates to the rotation position of the specific electrical angle and stops. Since no voltage is applied to the second motor 403 and the second motor is not controlled, the second motor is rotated by the rotation amount of the first motor 402.

After transitioning to Step S103, when a time T1 elapses, the process transitions from Step S104 to Step S105. The time T1 is set to be equal to or longer than the maximum time until the first motor 402 moves to the specific electrical angle position and completely stops when a predetermined fixed voltage is applied to the first motor 402. Although not illustrated in FIG. 7, the correction value of the first motor 402 is obtained at this timing, and the correct electrical angle can be detected.

Then, in Step S105, the CPU 301a outputs the control signal=2. As a result, the positioning voltage is applied to the second motor 403, and the second motor rotates to the rotation position of the specific electrical angle and stops. Since no voltage is applied to the first motor 402 and the first motor is not controlled, the first motor is rotated by the rotation amount of the second motor 403.

After transitioning to Step S105, when the time T1 elapses, the process transitions from Step S106 to Step S107. The time T1 is set to be equal to or longer than the maximum time until the second motor 403 moves to the specific electrical angle position and completely stops when a predetermined fixed voltage is applied to the second motor 403 as in Step S104. Although not illustrated in FIG. 7, the correction value of the second motor 403 is obtained at this timing, and the correct electrical angle can be detected.

By executing the flow from Step S103 to Step S106 before the motor control is started, it is possible to detect the correct electrical angles of the first motor 402 and the second motor 403 by using the pulse signal from the rotation position sensor 405.

Subsequently, rotation control of the first motor 402 and the second motor 403 is started. In Step S107, the control signal=3 is output. As a result, a voltage based on a voltage command output from the driving voltage command generation circuit 40115 is applied to a motor in both the first motor 402 and the second motor 403, the motor is rotationally controlled by a speed profile set in advance, and an image is output by the printer 150.

In Step S108, when the end of the image forming job is notified and a predetermined time T2 has elapsed, the process transitions from Step S109 to Step S110. The predetermined time T2 is a time until the motor decelerates from the target speed and stops.

In Step S110, the control signal-0 is set, and the control of the motor is ended.

In Step S111, when there is a command to turn off the power of the printer 150, the power is turned off. In a case where there is no command, the process returns to Step S102 and waits for the next image forming job.

The CPU 301a outputs the control signal as illustrated in the flowchart of FIG. 7. The motor control device 401 includes the first driving voltage generation circuit 4011 and the second driving voltage generation circuit 4012. In the first driving voltage generation circuit 4011 and the second driving voltage generation circuit 4012, the application timing of the positioning voltage is determined according to the control signal from the CPU 301a, and the timing deviates in order to obtain the correction value of the correct electrical angle.

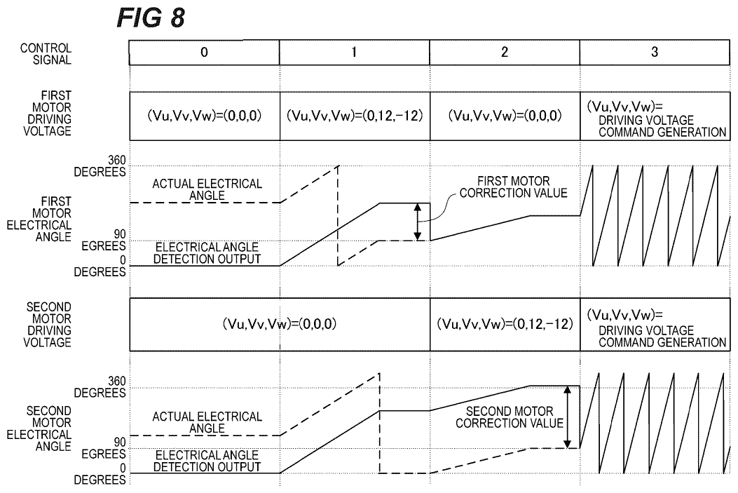

Finally, a flow from when the CPU 301a and the motor control device 401 are activated until the correction values of the electrical angles of the first motor 402 and the second motor 403 are acquired and control of both motors is started will be described with reference to FIG. 8. FIG. 8 is an explanatory diagram of a method of acquiring the correction value of the electrical angle of each of the first motor 402 and the second motor 403 in the present embodiment.

As described above, the switch 40118 of the first motor 402 outputs the positioning voltage with the control signal=1 from the CPU 301a, and outputs the driving voltage command with the control signals=0, 2, and 3 from the CPU 301a. In the case of the control signals 0 and 2 from the CPU 301a, the driving voltage command generation circuit 40115 is in an off state, and thus the control is not performed.

Similarly, the switch 40118 of the second motor 403 outputs the positioning voltage with the control signal=2 from the CPU 301a, and outputs the driving voltage command with the control signals=0, 1, and 3 from the CPU 301a. In the case of the control signals 0 and 1 from the CPU 301a, since the driving voltage command generation circuit 40115 is in the off state, the control is not performed.

The control signal from the CPU 301a outputs values of 0, 1, 2, and 3, and the value transitions in the order of 0, 1, 2, and 3.

In FIG. 8, when the power of the motor control device 401 is turned on, the control signal from the CPU 301a is 0. At this time, the driving voltage applied to both the motors is 0, and the electrical angle is also 0.

Then, when the control signal from the CPU 301a is 1, (U-phase voltage command, V-phase voltage command, W-phase voltage command)=(0 V, 12 V, −12 V) is applied to the first motor 402. As a result, the first motor 402 rotates and stops until reaching 90 degrees from the stopped electrical angle position. Since the electrical angle detection circuit 40116 in the first driving voltage generation circuit 4011 does not know the stopped electrical angle as illustrated in FIG. 8 and starts with the electrical angle=0, the output electrical angle is not 90 degrees.

Since the position where the first motor 402 is stopped is the rotation position of 90 degrees, a difference between the output of the electrical angle of the first motor 402 at this time and 90 degrees is the correction value. By setting this correction value, the electrical angle of the first motor 402 becomes a correct value, and the actual electrical angle of the motor and the output of the electrical angle detection circuit 40116 of the first motor 402 coincide with each other.

At this time, since a voltage is not applied to the second motor 403 and the second motor 403 is linked to the first motor 402 via the speed reducer 404, the second motor rotates and stops by the same amount as the first motor 402.

When the control signal from the CPU 301a is 2, (U-phase voltage command, V-phase voltage command, W-phase voltage command)=(0 V, 12 V, −12 V) is applied to the second motor 403. As a result, the second motor 403 rotates and stops until reaching 90 degrees from the stopped electrical angle position. Since the electrical angle detection circuit 40116 in the second driving voltage generation circuit 4012 does not know the stopped electrical angle as illustrated in FIG. 8 and starts with the electrical angle=0, the output electrical angle is not 90 degrees.

Since the position where the second motor 403 is stopped is the rotation position of 90 degrees, a difference between the output of the electrical angle of the second motor 403 at this time and 90 degrees is the correction value. By setting this correction value, the electrical angle of the second motor 403 becomes a correct value, and the actual electrical angle of the motor and the output of the electrical angle detection circuit 40116 of the second motor 403 coincide with each other.

At this time, since a voltage is not applied to the first motor 402 and the first motor 402 is linked to the second motor 403 via the speed reducer 404, the first motor rotates and stops by the same amount as the second motor 403. During this time, it is necessary for the electrical angle detection circuit 40116 to continue detection.

The correction values of the electrical angles of the first motor 402 and the second motor 403 can be obtained through the states of control signals=1 and 2 from the CPU 301a. Finally, by setting the control signal from the CPU 301a to 3, the voltage output from the driving voltage command generation circuit 40115 is applied to both motors, and control of both motors is started.

As described above, by performing the step of acquiring the correction values of the electrical angles of the two motors before the start of the motor control, in the configuration in which one load is controlled by the two motors, the rotation position information of the two motors can be generated from the position detection information of the load. As a result, it is possible to control the applied voltages based on the rotation positions of the motors with respect to the two motors with an inexpensive configuration without providing position detectors (rotary encoder, Hall element, or the like) in the two motors.

In the above embodiment, the specific electrical angle is the same electrical angle in the first motor 402 and the second motor 403, but may be different electrical angles.

Further, in the above embodiment, the configuration in which one load is controlled by two motors has been described. However, the present disclosure can be similarly applied to a configuration in which one load is controlled by one motor or a configuration in which one load is controlled by three or more motors.

According to the present disclosure, it is possible to provide a motor control device capable of obtaining motor driving performance equivalent to that of a configuration provided with a position detection sensor even though the position detection sensor provided for a motor is eliminated, and capable of achieving cost reduction, and an image forming apparatus equipped with the motor control device.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023291, filed Feb. 17, 2025, which is hereby incorporated by reference herein in its entirety.

What is claimed is:

1. A motor control device comprising:
a motor;
a driving target driven by the motor;
a position information detection unit configured to detect operation position information of the driving target; and
a driving control portion configured to generate electrical angle information of the motor based on position information detected by the position information detection unit when the motor is moved to a specific electrical angle position and information of the specific electrical angle position, and control driving of the motor.

2. The motor control device according to claim 1, wherein the driving control portion generates the electrical angle information of the motor by correcting electrical angle information obtained from position information detected by the position information detection unit with the information of the specific electrical angle position.

3. The motor control device according to claim 1, wherein the driving control portion generates the electrical angle information of the motor by correcting electrical angle information obtained from position information that is detected by the position information detection unit based on a difference between the electrical angle information obtained from the position information detected by the position information detection unit and the information of the specific electrical angle position.

4. The motor control device according to claim 1, wherein the driving target is a rotating member.

5. The motor control device according to claim 1, wherein the driving target is a photosensitive drum or a fixing roller.

6. The motor control device according to claim 1, wherein the driving control portion controls a speed of the driving target according to position information detected by the position information detection unit, and controls a driving current of the motor according to the electrical angle information of the motor.

7. The motor control device according to claim 1, wherein the driving control portion further includes a driving voltage generation unit that generates a driving voltage to be applied to the motor, and
the driving voltage generation unit generates the driving voltage to be applied to the motor based on the electrical angle information of the motor.

8. The motor control device according to claim 1, wherein the motor includes a first motor and a second motor, and
the motor control device further comprises
a driving force transmission unit that is connected to the first motor and the second motor, and is configured to compose a driving force of the first motor and a driving force of the second motor, and transmit a resultant force to the driving target.

9. The motor control device according to claim 8, wherein the driving force transmission unit is a speed reducer.

10. The motor control device according to claim 8, wherein the driving control portion generates electrical angle information of the first motor based on position information detected by the position information detection unit and the information of the specific electrical angle position by moving the first motor to the specific electrical angle position in a state where the first motor is connected to the driving force transmission unit and the second motor is disconnected from the driving force transmission unit, and generates electrical angle information of the second motor based on position information detected by the position information detection unit and the information of the specific electrical angle position by moving the second motor to the specific electrical angle position in a state where the second motor is connected to the driving force transmission unit and the first motor is disconnected from the driving force transmission unit.

11. The motor control device according to claim 10, wherein the driving force transmission unit is a speed reducer.

12. An image forming apparatus comprising:
the motor control device according to claim 1; and
an image forming section configured to form an image by the motor control device.
